(19) United States
(12) Patent Application Publication
(10) Pub. No.: US 2017/0261054 A1
(43) Pub. Date: Sep. 14, 2017

(54) WEDGE UNIT AND BRAKING DEVICE

(71) Applicant: SAF-HOLLAND GmbH, Bessenbach (DE)

(72) Inventor: Olaf Drews, Aschaffenburg (DE)

(73) Assignee: SAF-HOLLAND GmbH, Bessenbach (DE)

(21) Appl. No.: 15/510,087

(22) PCT Filed: Aug. 14, 2015
(86) PCT No.: PCT/EP2015/068728

§ 371 Date: Mar. 9, 2017

(30) Foreign Application Priority Data
Sep. 11, 2014 (DE) 102014218163.1

(51) Int. Cl. F16D 65/22

(52) U.S. Cl. CPC F16D 65/22; F16D 2121/14

(57) ABSTRACT

A wedge unit for a braking device with brake lining carriers includes a wedge configured to be displaced in an actuation direction for spreading the brake lining carriers, and an adjusting element configured to displace the wedge, wherein the wedge is displaceable to the adjusting element.

### BACKGROUND OF THE INVENTION

The invention concerns a wedge unit for a braking device, and a braking device, in particular a drum brake, with a wedge unit.

Wedge units for actuating brakes, in particular drum brakes, have been known for a long time in the prior art. In a wedge brake or wedge drum brake, to trigger the braking process, the brake lining carriers mounted pivotably on a brake carrier are pushed apart by means of a wedge. Thus the brake linings attached to the brake lining carriers make contact with the inside of the rotating brake drum and brake said brake drum. At their end facing the wedge, the brake lining carriers have so-called actuating pistons, the function faces of which are subjected to a pressure force by the wedge unit.

In known wedges with floating mounted wedges, the wedge shifts and hence assumes an oblique position, since because of the floating mounting of the wedge, a force equilibrium occurs at the wedge faces, i.e. actuating forces which are identical over the wedge are transmitted to the leading and trailing brake shoes. In other words, the wedge is pushed to one side with an axial lift, which leads to an oblique position. The result of the oblique position is angular difference between the wedge faces and the function faces of the actuating pistons which are moved by means of the wedge.

In former braking devices, this angular difference has not normally led to problems since a roller bearing is present between the wedge and the actuating piston, which compensates for the angular difference. The known roller bearings comprise a roller between each wedge face of the wedge and the corresponding adjacent function face of the actuating piston or brake lining carrier.

Under higher input forces and/or a greater translation due to a reduction in the wedge angle, in particular to achieve a greater braking moment, a higher surface pressure is applied to the raceways and rollers, which may limit the service life of the rollers or actuating pistons and/or wedge. It must also be recalled that the rollers press into the piston running face and can hence block the brakes.

The invention is based on the object of providing a wedge unit or actuating device for a braking device, and a corresponding braking device, which can also be configured for large braking forces.

### SUMMARY OF THE INVENTION

The wedge unit according to the invention for a braking device with brake lining carriers, in particular a wedge brake or wedge drum brake, comprises a wedge which can be shifted in an actuation direction, i.e. axial direction or lift direction, for spreading the brake lining carriers. The wedge unit furthermore comprises an adjusting element or lift element for shifting, in particular for performing a lift movement, of the wedge. According to the invention, the wedge is arranged displaceably or moveably relative to the adjusting element.

The braking device or drum brake according to the invention comprises a brake drum, at least two brake lining carriers arranged in the brake drum for carrying brake liners, and a wedge unit for spreading the brake lining carriers. The wedge unit is configured in the manner of the invention.

A first basic idea of the invention is to largely exclude or prevent an oblique position of the floating mounted wedge and hence an angle change of the wedge faces relative to the function faces of the actuating pistons which are actuated with the wedge. For this, the wedge unit is configured multi-piece and comprises a wedge and a separate adjusting element or lift element or actuating element for actuating the wedge. The wedge and the adjusting element are not rigidly connected together but are moveable relative to each other. Due to the multi-piece nature of the wedge unit and the movability between the wedge and the adjusting element, an axial shift of the wedge (in the actuation direction) can take place independently of a lateral displacement. The two movement directions, i.e. the axial direction or actuation direction firstly, and the lateral direction or transverse direction secondly, are thus decoupled from each other.

The invention allows the use of a bearing with a particularly low surface pressure, e.g. a needle bearing or multi-roller bearing, i.e. a bearing with at least two rollers per wedge face, at the interface between a floating mounted wedge and an actuating piston. In this way, the load at the interface can be reduced to an acceptable level even under high input forces. The wedge unit according to the invention guarantees that the function faces of the wedge and the actuating piston always remain at least almost parallel, which allows the use of said bearing for the first time.

A further basic idea of the invention may be regarded as the provision of a wedge unit, the wedge of which can be moved laterally, while retaining its angular position, at the same time as a lift movement (axial movement or displacement in the actuation direction). The lateral movement of the wedge may in particular take place independently of the movement of the adjusting element. It is preferably provided that the wedge, on an exclusively axial movement of the adjusting element, is moveable laterally or in the transverse direction, i.e. transversely to the lift direction or axial direction, while retaining its angular position.

The wedge is preferably mounted on the adjusting element moveably, in particular displaceably, in a transverse direction or a lateral direction relative, in particular vertically, to the lift direction or axial direction or actuation direction. The lateral displaceability of the wedge relative to the adjusting element guarantees firstly a reliable transmission of lift from the adjusting element to the wedge, and secondly a reliable orientation in the lift direction or axial direction. Thus on a lift movement, the adjusting element and wedge remain oriented preferably parallel to each other, in particular in the lift direction. Particularly preferably, the wedge is mounted on the adjusting element displaceably in a plane vertical to the lift direction. It is of particular advantage here if the wedge is mounted rotationally fixedly or non-pivotably on the adjusting element.

In principle, it is also conceivable that the wedge is mounted pivotably on the adjusting element, so that any oblique position of the adjusting element is not transmitted to the wedge.

In a preferred embodiment of the invention, the adjusting element has a pressure face which extends transversely, in particular vertically, to the actuation direction and along which the wedge is mounted displaceably, in particular in the transverse direction. Preferably, the adjusting element comprises a pressure plate on which the pressure surface is formed. The pressure face is preferably an axial face which extends transversely, in particular vertically, to the actuation direction or lift direction.

In a further preferred embodiment of the invention, the pressure face is a slip face for the wedge. In other words, the wedge is mounted sliding along the pressure face to give a lateral displaceability of the wedge relative to the pressure face. The pressure face thus serves to transmit the actuating forces or input forces or lift forces to the wedge.

Furthermore, it is proposed that the adjusting element has a piston rod or is formed as a piston rod. Preferably, the one-piece adjusting element has a piston rod extending from the pressure plate. At its distal end opposite the pressure plate, the piston rod preferably has a connecting region, in particular for connection of a brake cylinder.

To guide the wedge along the adjusting element, it is preferred that a guide structure, in particular a guide profile, is present at the interface between the wedge and the adjusting element. The guide structure or guide profile guides the wedge in the lateral direction. The guide structure is preferably configured such that an exclusively lateral movement of the wedge relative to the adjusting element is guaranteed. A lateral movement here means in particular a movement of the wedge in the direction of its opposing wedge faces.

In a particularly preferred embodiment of the invention, the adjusting element or the wedge has a fork head which is configured to guide an engagement element of the corresponding other part (wedge or adjusting element) or mount this displaceably in the transverse direction or lateral direction. The fork head may in particular comprise two or more webs between which an engagement element of the corresponding other part (wedge or adjusting element) is guided displaceably in the transverse or lateral direction. The fork head may also be formed by a toothed structure, for example on the axial end face of the pressure plate and/or the webs.

Furthermore, preferably a guide device is provided which guides the wedge in the transverse direction relative to the adjusting element. The guide device may in particular have a guide element which guides the wedge laterally along the adjusting element, and/or prevents or limits a movement of the wedge in the axial direction relative to the adjusting element. Preferably, the guide device is configured to allow a movement of the wedge exclusively in the transverse direction, i.e. the lateral shift direction. All other movement directions are preferably blocked or limited. The guide device may for example have a pin guided in an oblong slot.

According to a further preferred embodiment, at least one stop is provided which limits the movement, e.g. the lateral displaceability, of the wedge in the transverse direction. This in particular allows an increase in installation comfort, wherein the wedge for example may be mounted captively on the adjusting element by the stop.

The operational reliability may be improved if an axial guide is provided for the adjusting element, which guides the adjusting element in the actuation direction. The axial guide guides the adjusting element in particular such that this is moveable exclusively in the actuation direction. The axial guide thus prevents (within the limits of the predefined tolerances) a tilting or oblique positioning of the adjusting element. Since the adjusting element and the wedge are preferably always oriented parallel to each other, a tilting of the wedge element would be transmitted to the floating mounted wedge. The axial direction is in other words set and dimensioned in order to guarantee an exclusively axial movement of the adjusting element within the limits of the technical tolerances.

In a further preferred embodiment, a bearing device is provided for mounting the wedge, which for example has at least two rollers on a wedge face of the wedge or is configured as a needle bearing. Due to the plurality of rollers per wedge face of the wedge, or the configuration as a needle bearing, the surface pressure can be reduced and hence the service life and/or load-bearing capacity of the bearing increased.

As a whole therefore, one aspect of the invention may be that the wedge unit is constructed of multiple pieces and has a wedge and an adjusting element, wherein the adjusting element is arranged laterally displaceably relative to the wedge. The adjusting element preferably comprises a fork head with a large-area pressure plate and piston rod. The wedge element is e.g. mounted laterally displaceably via pins and linear recesses, i.e. floating, in the fork head, wherein the cylinder forces are transmitted axially via the large-area pressure plates to the wedge element, and from this via rollers or a needle bearing to the actuating pistons. The lateral displaceability of the wedge element may if required be limited so that a combination of a floating and rigid wedge results. The guidance of the pressure plate-piston rod is preferably dimensioned suitably to ensure an exclusively axial displaceability of the pressure plate with the fork head, since otherwise an angular difference could occur between the wedge faces and the actuating pistons.

### BRIEF DESCRIPTION OF THE DRAWINGS

The invention is explained in more detail below with reference to preferred embodiments which are depicted in the attached diagrammatic figures. The drawings show:

FIG. 1 is a lateral top view of a wedge unit according to the invention; and

FIG. 2 is a diagrammatic view of a braking device according to the invention.

The same or equivalent elements are marked with the same reference numerals in all figures.

### DETAILED DESCRIPTION OF THE PREFERRED EMBODIMENTS

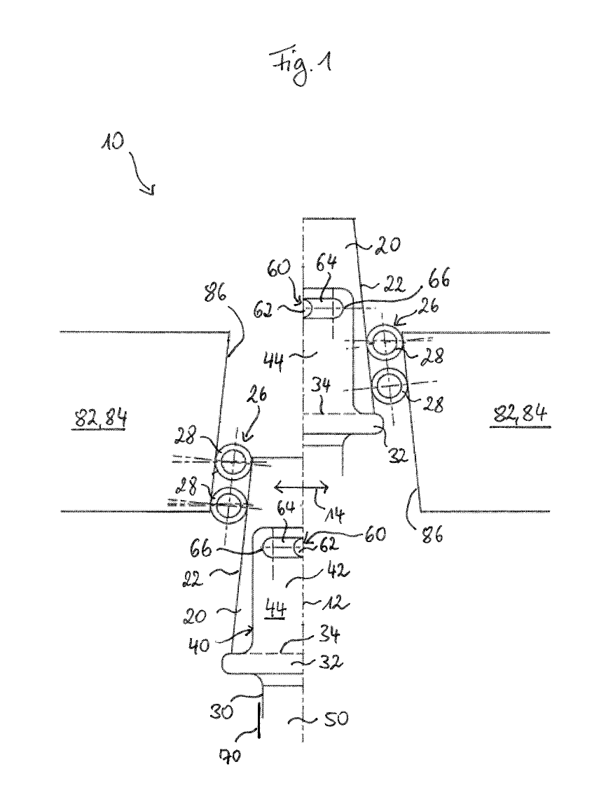

FIG. 1 shows a wedge unit 10 according to the invention of a braking device 100. The wedge unit 10 comprises a wedge 20, the center plane (plane of symmetry) of which is oriented parallel to an actuation direction 12 (axial movement direction, lift direction). The multi-piece wedge unit 10 furthermore comprises an adjusting element 30 for moving the wedge 20 in the actuation direction 12. The adjusting element 30 comprises a pressure plate 32 for moving the wedge 20 substantially in the actuation direction 12, so that the braking device 100 can be brought from an idle position into a braking position. For this, the pressure plate 30 comprises a pressure face 34 which extends substantially vertically to the actuating direction 12. The pressure face 34 cooperates with a corresponding opposite pressure face of the wedge 20.

The wedge 20 has opposing wedge faces 22 which are coupled via a bearing device 26, in particular a roller bearing, to a brake lining carrier 82 or an actuating piston 84 for actuation of a brake lining carrier 82.

The wedge 20 is mounted on the adjusting element 30 displaceably in a transverse direction 14 which runs substantially vertically to the actuation direction 12. The transverse direction 14 here in particular runs on a connecting line between the wedge faces 22 of the wedge 20. In this way, on uneven loading of its two wedge faces 22, the wedge may deviate laterally while the adjusting element 30 is guided in the actuation direction 12. This prevents the wedge 20 together with the adjusting element 30 from being positioned obliquely because of the different loads. The lateral displaceability of the wedge 20 relative to the adjusting element 30 thus guarantees that the wedge faces 22 always remain oriented parallel to the corresponding rolling faces 86 of the actuating pistons 84 or brake lining carriers 82, even if the actuating pistons 84 or brake lining carriers 82 are positioned differently on the two sides of the wedge 20. This allows the use of a bearing with a reduced surface pressure, for example a multi-roller bearing as shown in FIG. 1. The bearing device 26 here comprises several, for example two, rollers 28 per wedge face 22.

At its end facing the wedge 20, the adjusting element 30 has a guide contour 40 for guiding the wedge 20 in the transverse direction 14. The guide contour 40 may in particular be configured such that it prevents or limits a movement of the wedge 20 along the pressure face 34 in a direction running vertically or transversely to the transverse direction 40. The guide contour 40 may for example have one or more limiting walls 44 which extend in the transverse direction 14. In the embodiment shown, the adjusting element 30 at its end facing the wedge 20 has a fork head 42 which mounts the wedge 20 displaceably. The fork head 42 comprises several limiting walls 44 running in the transverse direction 14, between which the wedge 20 is mounted. The limiting walls 44 extend starting from the pressure plate 32, and together with the pressure plate 32 form a slotted recess for the wedge 20.

Below the pressure plate 32, a piston rod 50 is arranged which can be coupled to an actuating element, in particular a piston rod of a lift cylinder.

To prevent the wedge 20 from becoming detached from the adjusting element 30, a guide device 60 is provided which allows exclusively a movement of the wedge 20 in the transverse direction 14. In the exemplary embodiment shown, the guide device 60 comprises a pin 62 mounted on the wedge 20 and guided in a recess 64 of the fork head 42. In principle however the reverse arrangement is possible, i.e. the pin may be arranged on the fork head 42 or the adjusting element 30 and the linear recess on the wedge 20. The linear recess 64 runs in the transverse direction 14. End regions of the recess 64 each form a stop 66 which limits the movement of the wedge 20 in the transverse direction 14.

To ensure an exclusively axial movement of the adjusting element 30, an axial guide 70 is provided for the adjusting element 30. This is dimensioned and configured such that an oblique position of the adjusting element 30 is at least largely prevented.

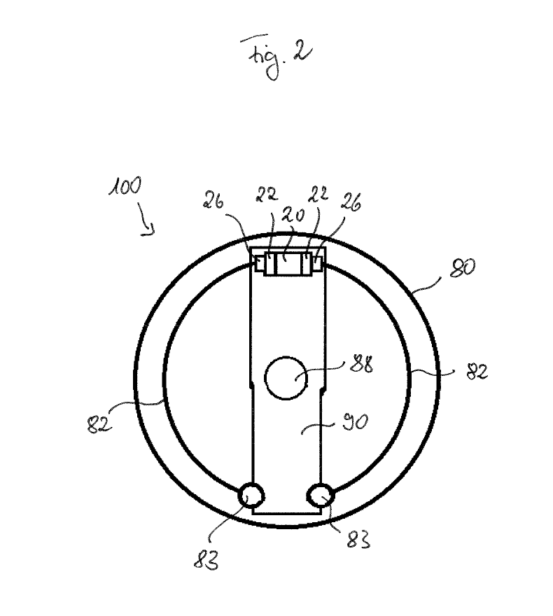

FIG. 2 shows, in heavily abstracted form, a braking device or drum brake 100 with a wedge unit 10. The braking device 100 comprises a brake drum 80, in the interior of which the brake pad carriers 82 are pivotably mounted on a brake carrier 90 via linkages 83. The brake carrier 90 is attached to an axle element 88. The brake lining carriers 82 are pressed apart via a wedge unit 10 according to the invention so that the brake linings mounted on the brake lining carriers 82 are pressed against the inside of the brake drum 80.

### REFERENCE NUMERALS

10 Wedge unit
12 Actuation direction
14 Transverse direction
20 Wedge
22 Wedge face
26 Bearing device
28 Roller
30 Adjusting element
32 Pressure plate
34 Pressure face
40 Guide contour
42 Fork head
44 Limiting wall
50 Piston rod
60 Guide device
62 Pin
64 Recess
66 Stop
70 Axial guide
80 Brake drum
82 Brake lining carrier
83 Linkage
84 Actuating piston
86 Rolling face
88 Axle element
90 Brake carrier
100 Braking device

1.-12. (canceled)

13. A wedge unit for a braking device with brake lining carriers, the wedge unit comprising:
a wedge configured to be displaced in an actuation direction for spreading the brake lining carriers; and
an adjusting element configured to displace the wedge;
wherein the wedge is displaceable relative to the adjusting element.

14. The wedge unit as claimed in claim 13, wherein the wedge is movably mounted on the adjusting element in the transverse direction relative to the actuation direction.

15. The wedge unit as claimed in claim 13, wherein the wedge is mounted pivotably on the adjusting element.

16. The wedge unit as claimed in claim 14, wherein the adjusting element includes a pressure face which extends transversely to the actuation direction and along which the wedge is mounted displaceably.

17. The wedge unit as claimed in claim 16, wherein the pressure face comprises a slip face for the wedge.

18. The wedge unit as claimed in claim 17, wherein the adjusting element includes a piston rod.

19. The wedge unit as claimed in claim 18, wherein at least one of the adjusting element and the wedge includes a fork head.

20. The wedge unit as claimed in claim 19, further comprising:
a guide device is provided which guides the wedge in the transverse direction relative to the adjusting element.

21. The wedge unit as claimed in claim 20, further comprising:
at least one stop is provided which limits the movement of the wedge in a transverse direction.

22. The wedge unit as claimed in claim 21, further comprising:
an axial guide for the adjusting element which guides the adjusting element in the actuation direction.

23. The wedge unit as claimed in claim 22, further comprising:
a bearing device for mounting the wedge, wherein the bearing device comprises at least one of at least two rollers on a wedge face of the wedge, and a needle bearing.

24. The wedge unit as claimed in claim 13, wherein the adjusting element includes a piston rod.

25. The wedge unit as claimed in claim 13, wherein at least one of the adjusting element and the wedge includes a fork head.

26. The wedge unit as claimed in claim 13, further comprising:
a guide device is provided which guides the wedge in the transverse direction relative to the adjusting element.

27. The wedge unit as claimed in claim 13, further comprising:
at least one stop is provided which limits the movement of the wedge in a transverse direction.

28. The wedge unit as claimed in claim 13, further comprising:
an axial guide for the adjusting element which guides the adjusting element in the actuation direction.

29. The wedge unit as claimed in claim 13, further comprising:
a bearing device for mounting the wedge, wherein the bearing device comprises at least one of at least two rollers on a wedge face of the wedge, and a needle bearing.

30. A drum brake comprising:
a brake drum;
at least two brake lining carriers arranged in the brake drum for carrying brake linings;
a wedge unit configured to spread the brake lining carriers, wherein the wedge unit includes a wedge configured to be displaced in an actuation direction for spreading the brake lining carriers; and
an adjusting element configured to displace the wedge; and
wherein the wedge is displaceable relative to the adjusting element.
